(19) United States
(12) Patent Application Publication
(10) Pub. No.: US 2013/0298939 A1
(43) Pub. Date: Nov. 14, 2013

(54) SYSTEM AND METHOD FOR CLEANING JEWELRY

(71) Applicant: Jacob Goldman, Bend, OR (US)

(72) Inventor: Jacob Goldman, Bend, OR (US)

(73) Assignee: BLUE WHITE & RED, INC., Bend, OR (US)

(21) Appl. No.: 13/893,722

(22) Filed: May 14, 2013

Related U.S. Application Data
(60) Provisional application No. 61/646,461, filed on May 14, 2012.

(51) Int. Cl. B08B 3/12; B08B 3/10; B08B 3/04

(52) U.S. Cl. CPC B08B 3/12; B08B 3/04; B08B 3/10
USPC 134/1; 134/18; 134/105

(57) ABSTRACT

In one embodiment, a system and method may be described for cleaning jewelry and precious items. The method may use an automated cleaning machine and submerge a basket constructed for holding jewelry in a bath of cleaning solution; soak jewelry in the basket for a predetermined time; automatically draining the cleaning solution after the predetermined time; and subsequent to the draining of the cleaning solution, automatically rinsing the jewelry at least one time in the basket with water heated to at least close to the boiling point.

### BACKGROUND

This Application claims priority to Provisional Patent Application No. 61/646,461, filed May 14, 2012. Provisional Patent Application No. 61/646,461 is incorporated herein by reference in its entirety.

### FIELD OF INVENTION

Embodiments of the present invention relate generally to cleaning systems, and more particularly to a system and method for cleaning jewelry.

### SUMMARY

Embodiments of the invention include a machine and/or method for cleaning precious items. A method for cleaning jewelry using an automated cleaning machine may comprise submerging a basket constructed for holding jewelry in a bath of cleaning solution; soaking jewelry in the basket for a predetermined time; automatically draining the cleaning solution after the predetermined time; and subsequent to the draining of the cleaning solution, automatically rinsing the jewelry at least one time in the basket with water heated to at least close to the boiling point.

A machine for automatically cleaning jewelry may comprise a housing; a compartment within the housing adapted to hold jewelry and arranged to submerge the jewelry in one of a cleaning solution and rinse water; a sprinkler disposed in the housing above the compartment; a first reservoir in the housing to hold clean rinse water and coupled by a pipe to deliver clean rinse water to the sprinkler; a second reservoir in the housing to hold used cleaning solution and coupled to the compartment by a pipe having a first controllable valve biased in a closed state; a third reservoir in the housing to hold waste rinsed water and coupled by a pipe having a second controllable valve to the compartment biased in a closed state; a controllable heater in the housing arranged to heat the rinse water delivered to the sprinkler; a programmable controller coupled to the heater, and the first and second controllable valves, wherein the controller is programmed to maintain the jewelry submerged in the cleaning solution for a predetermined soak time and then to open the first controllable valve to drain used cleaning solution into the second reservoir, wherein the controller is programmed to control the heater to heat clean rinse water delivered to the sprinkler to sprinkle hot water over the jewelry in the compartment for a predetermined time followed by opening the second controllable valve to drain waste rinse water from the compartment into the third reservoir.

### BRIEF DESCRIPTION OF THE DRAWINGS

The foregoing and other features and advantages of the invention will be apparent from the following, more particular description of various exemplary embodiments, as illustrated in the accompanying drawings.

FIG. 1 depicts a front view of an embodiment of a jewelry cleaning system;

FIG. 2 depicts an illustrative system diagram for use with an example system and method of cleaning jewelry and precious items;

FIG. 3 depicts an example workflow of an embodiment of a jewelry cleaning system; and

FIG. 4 depicts an example diagram of an embodiment of a jewelry cleaning system

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

As used herein, the term “a” refers to one or more. The terms “including,” “for example,” “such as,” “e.g.,” “may be” and the like, are meant to include, but not be limited to, the listed examples. The term “product” may refer to both products and services.

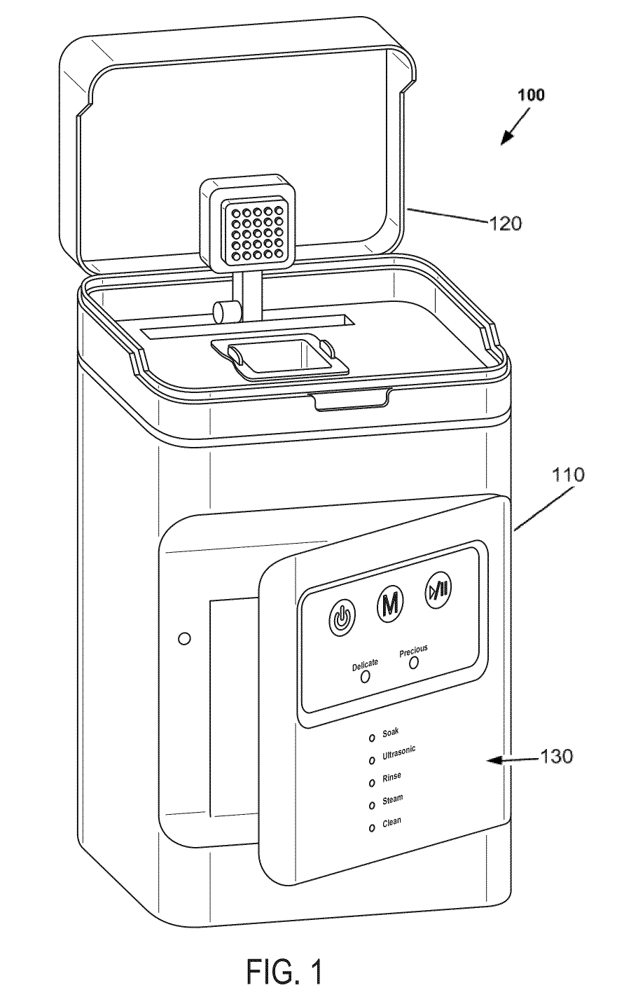

FIG. 1 depicts a front view of an embodiment of a jewelry cleaning system 100. An embodiment of jewelry cleaning system 100 cleans jewelry using cleaning solution, hot water/steam, and ultrasonic waves through at least a combination of one or more microprocessors, heating elements, containers for liquids, fans, ultrasonic transducers, sensors, and internal tubing.

Jewelry cleaning system 100 may include various stages such as soak, ultrasonic, rinse, steam, and/or clean stages. These stages may be indicated by, for example, an LED (e.g., a status light). The LED may indicate which stage is currently active in Jewelry cleaning system 100. Depending on the mode selected and internal sensors, Jewelry cleaning system 100 may proceed through the stages for various lengths of time. Depending on the mode selected and the internal sensors, not all stages may be activated manually and the stages may not necessarily proceed sequentially. For example, jewelry cleaning system 100 may also include precious and delicate modes. These modes may vary the amount and frequency of ultrasonic cleaning. Also, a speed mode may be available that may shorten the total cleaning time. For example, the amount of time jewelry remains soaking in a cleaning solution may be shortened or skipped entirely.

Jewelry cleaning system 100 front door 110 may be opened and the water collection container may be removed and filled with regular tap water, for example, up to a “fill” mark.

A water collection container may be stored in jewelry cleaning system 100. Top door 120 of jewelry cleaning system 100 may be opened and water may be poured into a fresh water tank in the back of the unit. Jewelry cleaning system 100 may be designed to accommodate slight water spills and may drain extra water into the fresh water tank stored in jewelry cleaning system 100.

The empty water collection container may be stored next to a cleaning solution collection container inside jewelry cleaning system 100. The cleaning cycle may not begin unless both the water collection container and the cleaning solution collection container are located inside jewelry cleaning system 100.

Jewelry cleaning system 100 may also house a jewelry basket. The jewelry basket may be removable and may be accessed through top door 120. Jewelry may be placed in the jewelry basket.

Once jewelry is placed in the jewelry basket and jewelry basket is placed in jewelry cleaning system 100, cleaning solution may be applied. The supplied non-toxic and biodegradable cleaning solution may be used to fill jewelry basket until the jewelry in the basket is well-covered and submerged. The cleaning solution can be any cleaning solvent sold for the purpose of jewelry cleaning. For example, an embodiment of the invention may use a cleaning solution based on the Magic Green cleaning product. Once the cleaning solution is applied, top door 120 of jewelry cleaning system 100 may be closed.

In an example embodiment of a user interface for jewelry cleaning system 100. An “On” button may be selected and a cleaning Mode may also be selected. For example, a “delicate” mode may turn off the ultrasonic process to safeguard pearls, custom jewelry, soft or porous stones, and/or any jewelry that uses cement to hold stones in place. A “precious” mode, for example, may activate the ultrasonic process to clean diamonds, gold, silver, platinum, and other precious stone and metal jewelry. A speed mode may skip the cleaning solution soak cycle for example.

A “start” button may be selected and the jewelry cleaning system 100 may begin working.

After the “start” button is selected, jewelry cleaning system 100 status indicators 130 may indicate the current stage of the jewelry cleaning system 100. For example, first, the “soak” light may come on for a period of time (e.g., 30 minutes) while the jewelry cleaning system 100 soaks jewelry in the cleaning solution. In “precious” mode, for example, the jewelry cleaning system 100 may activate an ultrasonic process a number of times during the soak for further dirt and grease penetration. The ultrasonic process may include a 42,000 Hz and/or 80,000 Hz ultrasonic cleaner. Status indicators 130 may include at least the following indicators soak, ultrasonic, rinse, steam, clean, delicate, precious, and/or speed mode.

Jewelry cleaning system 100 may house both a cleaning solution collection container and a water collection container. Both containers may be accessible via front door 110. In an example embodiment the cleaning solution may be returned to the cleaning solution collection container. For example, after a number of minutes (e.g., 30 minutes), the jewelry cleaning system 100 may automatically drain the cleaning solution into the cleaning solution container for use with future cleaning. After the jewelry and precious items are cleaned with the cleaning solution, hot water and/or steam may be used to further clean and rinse the jewelry and precious items. The hot water and/or condensed steam may be drained into the water collection container.

In a rinse cycle, jewelry cleaning system 100 may automatically fill the jewelry basket with hot water (e.g., boiling water or near boiling water) for a period of time (e.g., five-minute) for soaking. In “precious” mode, for example, jewelry cleaning system 100 may also activate the ultrasonic process a number of times during a first soak to make sure all dirt and cleaning solution is removed. Several rounds of soaking may occur where hot water is supplied to the jewelry basket for several minutes after which the dirty water is removed. In one embodiment, the clean rinse water may be delivered using a heating element that heats the water and uses a one-way valve forcing the hot/steamy water into the jewelry cup. In one embodiment, hot water may be delivered to the jewelry basket in the same mechanism as used in a drip coffee maker, for example.

At a pre-selected time (e.g., the five-minute mark), the jewelry cleaning system 100 may drain the dirty water into the water collection container and may fill the jewelry basket with fresh hot water. The process may be repeated several times (e.g., a third rinse).

In one embodiment, at the bottom of the jewelry cup, two valves may be mounted above the water collection container (e.g., container to collect the water used to rinse the jewelry) and the smaller cleaning solution container (e.g., container to collect the used cleaning solution). The valves will open and close based on the pre-programmed procedure embedded in a controller (e.g., microprocessor).

A steam bath may be applied to restore the jewelry's brilliance and may remove any water spots left by the soak and rinse cycles.

After a cooling period (e.g., one-minute) the clean light may illuminate and the cleaned jewelry may be removed. The entire process may take less than an hour.

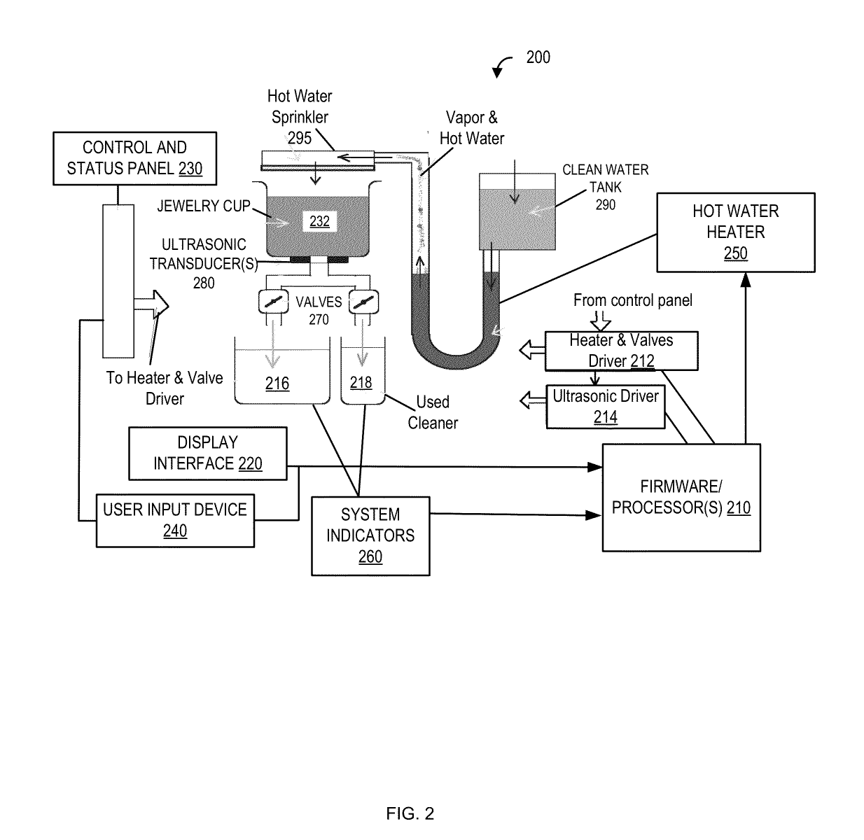

FIG. 2 depicts an illustrative system diagram 200 for use with an example system and method of cleaning jewelry and precious items using jewelry cleaning system 100. Specifically, FIG. 2 depicts an illustrative embodiment of a cleaning system 200 that may be used in an embodiment of the invention described herein. The present invention (or any part(s) or function(s) thereof) may be implemented using hardware, software, firmware, or a combination thereof and may be implemented in one or more systems capable of performing various steps or processes (e.g., processing systems, such as, a standalone device or computer systems).

Cleaning system 200 may include one or more processors, such as, e.g., but not limited to, processor(s) 210. Cleaning system 200 may also include heater and values driver 212, ultrasonic driver 214, display interface 220, control and status panel 230, user input device 240, hot water heater 250, system indicators 260, valves 270, ultrasonic transducer(s) 280, clean water tank 290, and/or hot water sprinkler 295.

Processor(s) 210 may be part of, connected to, and/or in communication with heater and values driver 212, ultrasonic driver 214, display interface 220, control and status panel 230, user input device 240, hot water heater 250, system indicators 260, valves 270, and/or ultrasonic transducer(s) 280. Processor(s) 210 may also be connected to a communication infrastructure (e.g., but not limited to, a communications bus, cross-over bar, interconnect, or network, etc.). Processor 210 may include any type of processor, microprocessor, firmware, and/or processing logic that may interpret and execute instructions (e.g., for example, a field programmable gate array (FPGA)). The processor 210 may include logic configured to execute computer-executable instructions configured to implement one or more embodiments of the invention described herein.

In one embodiment, printed circuit boards (PCBs) may be used to control the wash cycle and to display status of cleaning system 200. For example, the following three PCBs may be used. A CPU PCB, for example, may be mounted in the front door and may host all the LED indicators (e.g., system indicators 260) as well as a processing unit. Furthermore, the CPU PCB may control another two PCBs. A control PCB (e.g., heater and valves driver 212), for example, may be controlling two valves (e.g., cleaning solution and water drainage valves) and the heating element 250 and may receive instructions from the CPU PCB. The control PCB may be mounted at the back of cleaning system 200. An ultrasonic driver 214, for example, may control the ultrasonic transducer 280. Ultrasonic transducer 280 may be attached to the bottom of jewelry basket 232 and may be driven by ultrasonic driver 214 PCB. Ultrasonic driver 214 PCB may be mounted at the bottom of cleaning system 200 and may have one or more dedicated cooling fans and one or more cooling openings in the cleaning system 200.

Heater and values driver 212 and/or processor 210 may control hot water heater 250 and valves 270. Heater and valves driver 212 may determine when hot water heater 250 is activated and temperature control for hot water heater 250. Heater and valves driver 212 and/or processor 210 may communicate with hot water heater 250 at designated times during a cleaning cycle to provide hot water and/or steam. Hot water heater 250 may receive water from clean water tank 290. Hot water heater 250 may provide hot water and/or steam to hot water sprinkler 295. Hot water sprinkler 295 may provide hot water and/or steam into jewelry basket 232. In one embodiment, sprinkler 295 may be arranged in the lid covering the jewelry compartment. Sprinkler 295 may be connected via tubing to hot water heater 250 to allow hot water/steam to be ejected from sprinkler 295.

Heater and valves driver 212 may operate valves 270 by determining when and which valves 270 are opened and/or closed. Valves 270 may include drainage valves for at least drainage of the cleaning solution and/or the used water from jewelry basket 232. Heater and valves driver 212 may determine when and if the liquid in jewelry basket 232 should be drained to water collection container 216 or cleaning solution container 218.

Ultrasonic driver 214 may control ultrasonic transducer(s) 280. Ultrasonic transducer(s) 280 may contain one or more ultrasonic transducers. Ultrasonic driver 214 may determine when ultrasonic transducer(s) 280 are activated and may determine the frequency of ultrasonic transducer(s) 280. In one embodiment, the ultrasonic transducer(s) 280 may operate at 80,000 Hz. Ultrasonic transducer(s) 280 may be custom made for cleaning system 200 and may be approximately 28 mm in diameter and deliver 18 Watt.

Display interface 220 may forward data, (e.g., but not limited to, graphics, text, and other data, etc.), from the processor 210 for display on, for example, control and status panel 230. Control and status panel 230 may include, for example, a series of LEDs, an LCD screen, a television, a computer monitor, or a mobile phone screen. Control and status panel 230 may include or be part of display interface 220 and user input device 240. Output may also be provided as sound through a speaker.

Cleaning system 200 may also include a user input device 240 which may include any mechanism or combination of mechanisms that may permit information to be input into cleaning system 200 from, e.g., a user. Input device 240 may include, for example, button or buttons for selecting a mode (e.g., delicate or precious), start, stop, pause, power, etc. Other examples of input device 240 may include, e.g., but not limited to, a touch sensitive display device, a keyboard, a biometric input device, a microphone. Input device 240 may communicate with processor 210 either wired or wirelessly. User input device 240 may include or interface with control and status panel 230.

Cleaning system 200 may also include system indicators 260. Processor 210 may communicate with system indicators 260 to receive indications of the current state of the system. For example, system indicators 260 may communicate with processor 210 that the front door open and/or water collection container 216 and/or cleaning solution container 218 are not properly placed inside jewelry cleaning system 100. Based on the status provided by system indicators 260, cleaning system 200 may prohibit user activation of jewelry cleaning and/or inhibit hot water heater 250, for example. Additionally, control and status panel 230 and/or display interface 220 may provide an error indication indicating an error state within cleaning system 200 and cleaning system 200 may not be activated based on status of system indicators 260.

In one embodiment, cleaning system 200 may include a housing and jewelry cup 232 (e.g., a compartment) located within the housing and adapted to hold jewelry. Jewelry cup 232 may be arranged to submerge jewelry in one of a cleaning solution and/or rinse water. Hot water sprinkler 295 may be disposed in the housing above jewelry cup 232. A clean water tank 290 (e.g., a first reservoir) may be located in the housing to hold clean rinse water and may be coupled by a pipe to deliver clean rinse water to hot water sprinkler 295. Cleaning solution container 218 (e.g., a second reservoir) in the housing may hold used cleaning solution and may be coupled to the jewelry cup 232 by a pipe having a first controllable valve biased in a closed state. Water collection container 216 (e.g., a third reservoir) may be located in the housing and may be used to hold waste rinse water and coupled by a pipe having a second controllable valve to the compartment biased in a closed state. Hot water heater 250 (e.g., a controllable heater) may be located in the housing and may be arranged to heat the rinse water delivered to hot water sprinkler 295. Ultrasonic transducer 280 may be connected to jewelry basket 232 and may also be coupled ultrasonic driver 214. Ultrasonic transducer 280 may be activated for a predetermined period during at least the predetermined soak time.

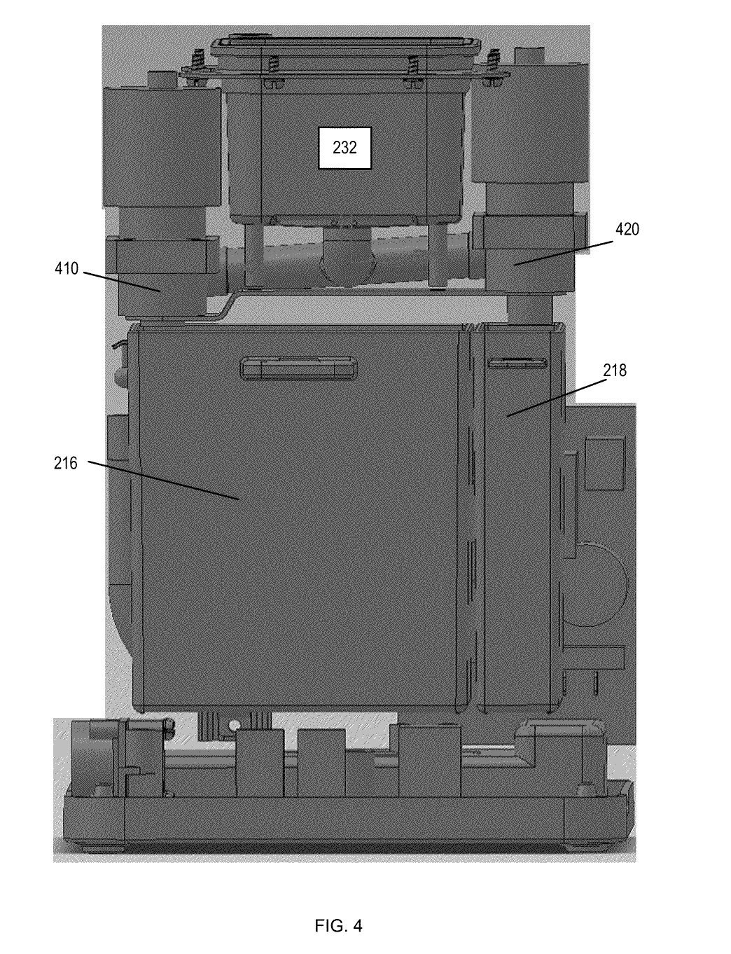

Heater and valves driver 212 (e.g., a programmable controller) may be coupled to hot water heater 250, and the first and second controllable valves 270 (e.g., see FIG. 4, cleaning solvent valve 420 and clean water valve 410), wherein heater and valves driver 212 may be programmed to maintain the jewelry submerged in the cleaning solution for a predetermined soak time and then to open a first controllable valve (e.g., see FIG. 4, cleaning solvent valve 420) to drain the drain used cleaning solution into cleaning solution container 218, wherein heater and valves driver 212 may be programmed to control hot water heater 250 to heat clean rinse water delivered to hot water sprinkler 295 to sprinkle hot water over the jewelry in the jewelry cup 232 for a predefined time followed by opening the second controllable valve (e.g., see FIG. 4, clean water valve 410) to drain waste rinse water from the compartment into the water collection container 216. Heater and valves driver 212 may heat the water delivered to hot water sprinkler 295 to generate steam. Heater and valves driver 212 may open clean water valve 410 to drain waste from jewelry basket 232 followed by activation of hot water heater 250 to generate steam that may be delivered to jewelry basket 232 by hot water sprinkler 295.

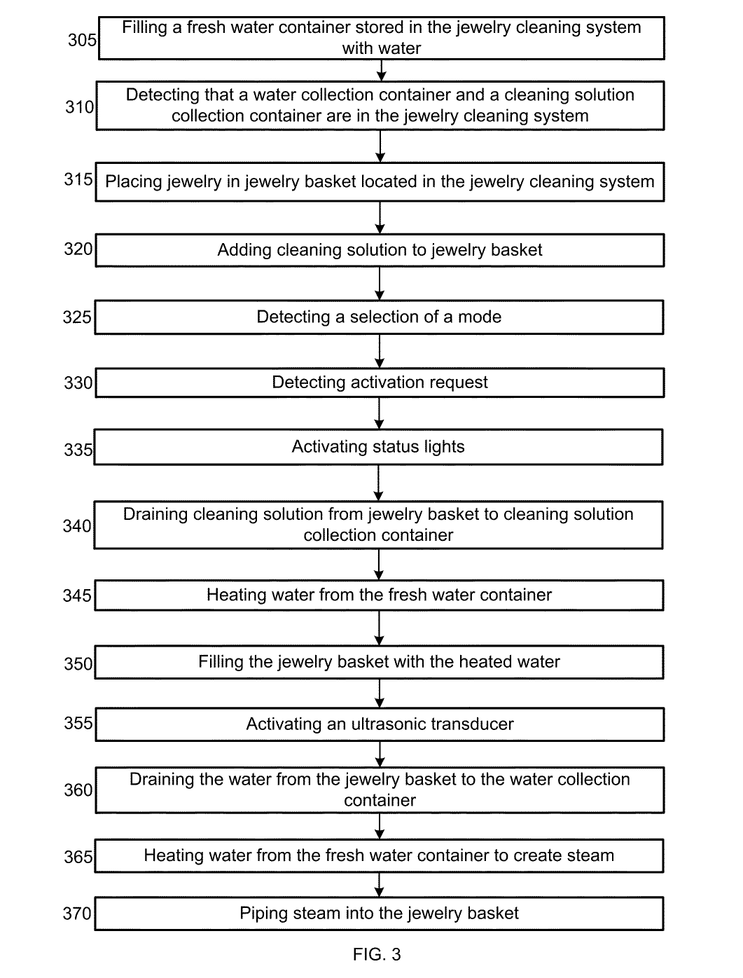

FIG. 3 depicts an example workflow of an embodiment of a jewelry cleaning system. An example embodiment of the invention may include the following steps.

At 305, a water collection container 216 (or other container) may be filed with water (e.g., tap water) to a fill line. The water may be poured into clean water tank 290 of jewelry cleaning system 100. The water collection container 216 may be stored in jewelry cleaning system 100. From 305, flow may move to 310.

At 310, empty water collection container 216 may be placed back inside the jewelry cleaning system 100 and the front door may be closed. Jewelry cleaning system 100 may have sensors to detect water collection container 216 and cleaning solution collection container 218 are placed in jewelry cleaning system 100. The cleaning cycle may not begin unless both containers, water collection container 216 and cleaning solution collection container 218 are located inside the jewelry cleaning system 100. From 310, flow may move to 315.

At 315, jewelry may be placed into jewelry basket 232. From 315, flow may move to 320.

At 320, cleaning solution may be used to fill jewelry basket 232 until the jewelry is well-covered and submerged. Once the jewelry is covered top door 120 to jewelry cleaning system 100 may be closed. From 320, flow may move to 325.

At 325, a selection of a mode may be detected. For example, the selection of a combination of fast, delicate, and/or precious may be selected. For example, “Delicate” mode may turn off the ultrasonic process to safeguard pearls, costume jewelry, soft or porous stones, and/or any jewelry that uses cement to hold stones in place, for example. “Precious” mode may activate the ultrasonic process for cleaning of diamonds, gold, silver, platinum, and other precious stone and metal jewelry. The default Mode of operation is the “delicate” mode. To set the “Precious” mode, the M button may need to be pressed for at least 1 second to ensure inadvertent selection of the wrong mode, for example. From 325, flow may move to 330.

At 330, an activation request may be received. For example, the “ON” button may be pressed. From 330, flow may move to 335.

At 335, status indicators 130 may be activated. For example, the jewelry cleaning system 100 may have status lights to indicate the current stage of operation. For example, a “Soak” light may be illuminated for a period of time (e.g., 30 minutes) while jewelry cleaning system 100 soaks jewelry in the cleaning solution. In “precious” mode, for example, jewelry cleaning system 100 may activate the Ultrasonic process during the soak for further dirt and grease penetration. When that happens, the UltraSonic status light may be illuminated. Depending on the selected mode, ultrasonic transducer 280 may be activated during the soaking period. From 335, flow may move to 340.

At 340, after a period of time (e.g., 30 minutes), jewelry cleaning system 100 may automatically drain the cleaning solution into the cleaning solution collection container 218 for future reuse. From 340, flow may move to 345.

At 345, water from water tank 290 may be heated to boiling or near boiling using hot water heater 250. From 345, flow may move to 350.

At 350, a rinse cycle may begin. Jewelry cleaning system 100 may automatically fill the jewelry basket with hot water, for soaking for a period of time (e.g., a five-minutes). From 350, flow may move to 355.

At 355, ultrasonic transducer 280 may be activated. For example, in “Precious” mode, jewelry cleaning system 100 may also activate the ultrasonic process during the first rinse to remove dirt and cleaning solution. Ultrasonic transducer 280 may be activated several times during various stages of cleaning. From 355, flow may move to 360.

At 360, the water from jewelry basket 232 may be drained into water collection container 216. For example, at the five-minute mark, jewelry cleaning system 100 may drain the dirty water into the water collection container 216 and may fill the jewelry basket again with fresh hot water. The process may be repeated. From 360, flow may move to 365.

At 365, hot water heater 250 may heat water from water tank 290 to create steam. From 365, flow may move to 370.

At 370, steam may be piped into jewelry basket 232. For example, following the three rinse cycles (e.g., steps 345-360), a steam bath may restore jewelry's brilliance and may remove any water spots left by the soak and rinse cycles.

After 370, a cooling period (e.g., one minute) may allow the jewelry to cool and a clean light may illuminate in status indicators 130. The entire cleaning process may take less than an hour.

In another embodiment, cleaning system 200 may be automated and may include the following steps. First, a basket constructed for holding jewelry may be submerged in a bath of cleaning solution. The jewelry may be soaked in the basket for a predetermined time. Depending on a mode selected, the jewelry in the basket may be subjected to ultrasonic vibrations during the soaking. The cleaning solution may be automatically drained after the predetermined time into a removable container located in cleaning system 200.

The jewelry in the basket may be automatically rinsed by, for example, submerging the jewelry in the basket and/or the basket itself at least one time with water heated to at least close to the boiling point. Depending on a mode selected, the jewelry in the basket may be subjected to ultrasonic vibrations during the rinsing. The cleaning solution may be drained after the predetermined time. The jewelry in the basket may be automatically subjected to steam after the rinsing step. The heated water and/or condensed steam may the drained into a removable container located in the cleaning system 200 after a predetermined period of rinsing.

FIG. 4 depicts an example diagram of an embodiment of a jewelry cleaning system. Clean water valve 410, allows water to drain from jewelry basket 232 into water collection container 216. Cleaning solvent valve 420, allows the used cleaning solution to drain into cleaning solution container 218.

In one embodiment, the tube leading the cleaning water and cleaning solvent from jewelry basket 232 to the collecting containers may not be level. Cleaning solvent valve 420 may be slightly elevated over clean water valve 410. Accordingly, during each cleaning, a portion of the cleaning solution may be deposited in the water collection container 216 and not all the cleaning solvent may end up in cleaning solution container 218. For example, during a cleaning cycle some of the cleaning solution may be trapped in the slanted tube and end up in water collection container 216. Accordingly, the user of cleaning system 200 will have to provide and/or purchase new cleaning solution. Thus, the cleaning solution may need to be purged and replaced with new and fresh cleaning solution. Additionally, because of the angle of the tube between cleaning solvent valve 420 and clean water valve 410, the rinse water will not contaminate the cleaning solvent. No rinse water will flow into cleaning solution container 218.

Embodiments of cleaning system 200 may also include memory that may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, as well as erasable programmable read only memory (EPROM), or programmable read only memory (PROM) etc.

Cleaning system 200 may also include input/output (I/O) devices such as, a network interface card, USB, Firewire, and/or modems, that may communicate with processor 210 either wired or wirelessly.

In this document, the terms “computer program medium” and “computer readable medium” may be used to generally refer to media such as, e.g., but not limited to, removable storage drives, hard disks installed in hard disk drives, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to cleaning system 200 and/or a computer system. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating, ” “determining,” or the like, refer to the action and/or processes of a computer or computing system, or similar electronic computing device, that may manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application.

According to another embodiment, embodiments may be represented by any of a number of well-known network architecture designs including, but not limited to, peer-to-peer, client-server, hybrid-client (e.g., thin-client), or standalone.

While various embodiments of the present invention have been described above, it should be understood that they have been presented by way of example only, and not limitation.

What is claimed is:

1. An method for cleaning jewelry using an automated cleaning machine, comprising:
submerging a basket constructed for holding jewelry in a bath of cleaning solution;
soaking jewelry in the basket for a predetermined time;
automatically draining the cleaning solution after the predetermined time; and
subsequent to the draining of the cleaning solution, automatically rinsing the jewelry at least one time in the basket with water heated to at least close to the boiling point.

2. The method according to claim 1, further comprising automatically subjecting the jewelry in the basket to ultrasonic vibrations during the soaking in dependence on a selected cleaning mode.

3. The method according to claim 1, further comprising automatically subjecting the jewelry in the basket to ultrasonic vibrations during the rinsing step.

4. The method according to claim 1, further comprising automatically subjecting the jewelry in the basket to steam after the rinsing step.

5. The method according to claim 1, wherein the rinsing step includes submerging the basket with jewelry in the heated water.

6. The method according to claim 4, further including automatically draining the heated water into a container located in the cleaning machine after a predetermined period of soaking the jewelry in the cleaning solution.

7. The method according to claim 1, further including automatically draining the cleaning solution into a container located in the cleaning machine.

8. An machine for automatically cleaning jewelry, comprising:
a housing;
a compartment within the housing adapted to hold jewelry and arranged to submerge the jewelry in one of a cleaning solution and rinse water;
a sprinkler disposed in the housing above the compartment;
a first reservoir in the housing to hold clean rinse water and coupled by a pipe to deliver clean rinse water to the sprinkler;
a second reservoir in the housing to hold used cleaning solution and coupled to the compartment by a pipe having a first controllable valve biased in a closed state;
a third reservoir in the housing to hold waste rinse water and coupled by a pipe having a second controllable valve to the compartment biased in a closed state;
a controllable heater in the housing arranged to heat the rinse water delivered to the sprinkler; and
a programmable controller coupled to the heater, and the first and second controllable valves, wherein the controller is programmed to maintain the jewelry submerged in the cleaning solution for a predetermined soak time and then to open the first controllable valve to drain used cleaning solution into the second reservoir, wherein the controller is programmed to control the heater to heat clean rinse water delivered to the sprinkler to sprinkle hot water over the jewelry in the compartment for a predetermined time followed by opening the second controllable valve to drain waste rinse water from the compartment into the third reservoir.

9. The machine according to claim 8, and further including an ultrasonic transducer connected to the compartment and coupled to the controller to be activated for a predetermined period during at least the predetermined soak time.

10. The machine according to claim 8, wherein the controller heats the water delivered to the sprinkler to generate steam.

11. The machine according to claim 10, wherein the controller opens the second controllable valve to drain waste water from the compartment followed by activation of the heater to generate steam that is delivered to the compartment by the sprinkler.
